(19) United States
(12) Patent Application Publication
(10) Pub. No.: US 2009/0204753 A1
(43) Pub. Date: Aug. 13, 2009

(54) SYSTEM FOR REFRESHING CACHE RESULTS

(75) Inventors: William Havinden Bridge, JR., Alameda, CA (US); Flavio P. Junqueira, Barcelona (ES); Vassilis Plachouras, Barcelona (ES)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/028,373

(22) Filed: Feb. 8, 2008

(51) Int. Cl. G06F 12/00

(52) U.S. Cl. 711/106; 711/E12.001

(57) ABSTRACT

A system and method for refreshing a cache based on query responses provided by a searching system in response to queries, includes providing a cache entry for each unique query, if space is available in the cache, and assigning a temperature value to each cache entry based on a frequency of occurrence of the corresponding query An age value is assigned to each cache entry based on a time of last refresh or creation of the corresponding query response. The age of the cache entries is periodically updated, and the temperature of a cache entry is updated when a corresponding query reoccurs. If system resources are available, the query response of a cache entry is refreshed based on the temperature and age of the cache entry. If resources are not available, the refreshing is limited.

### TECHNICAL FIELD

The present invention relates to a system for updating or refreshing cache results.

### BACKGROUND

Caching is an efficient technique for reducing the workload of back-end servers in client-server systems. A cache is a fast-access memory that stores results computed for previous client requests. A client may submit a search request containing a query string to a search engine system. To reduce the request traffic processed by back-end servers, the query results, which are links to documents on the World Wide Web (Web), may be cached. This technique reduces the number of requests to be processed and the workload of the back-end servers.

Search engine systems provide pointers to documents on the Web. The set of available documents is constantly evolving, and search engine systems typically update their databases through a process referred to as “crawling.” Crawling permits the database to be updated with respect to new pages, modified pages, and pages that may no longer exist. Although crawling improves the “freshness” of results in response to the client query, it poses certain problems to caching because when the database is updated, the results stored in the cache may not reflect the updated results in the database. Thus, the results in the cache may be stale. Note that the results returned by search engines reflect the state of the Web some time in the past, but the user cannot really know this because the Web is constantly evolving and changing. In any event, this does not significantly impact the user if the difference in time is small.

Flushing the contents of the entire cache after database updates have occurred may assure that the cache results are current. However, this is inefficient and causes a significant reduction on the cache hit ratio, and essentially defeats the purpose of caching. Accordingly, there is a need to efficiently update the cache while maintaining a high cache hit ratio.

### BRIEF SUMMARY

In one aspect, a method for refreshing a cache based on query responses provided in response to queries includes providing a cache entry for each unique query, if space is available in the cache, and assigning a temperature value to each cache entry based on a frequency of occurrence of the corresponding query. An age value is assigned to each cache entry based on a time of last refresh or creation of the corresponding query response. The age value of the cache entries is periodically updated, and the temperature value of a cache entry is updated when a corresponding query reoccurs. If computational resources are available, the query response of a cache entry is refreshed based on the temperature value and the age value of the cache entry. If computational resources are not available, the refreshing is limited.

In another aspect, a cache management system includes a processor in communication with a cache, where the cache has a plurality of cache entries. A server is configured to receive a user query and provide a query response to the processor. A bucket storage structure is accessible by a temperature index and an age index, where a location in the bucket storage structure defined by the temperature index and age index contains an indication of the cache entry assigned the corresponding temperature and age. A temperature value is assigned to each cache entry based on a frequency of occurrence of the corresponding user query, and an age value is assigned to each cache entry based on a time of last refresh or creation, of the corresponding query response. A refresh scheduler periodically updates the assigned age of the cache entries, and updates the temperature value of a cache entry when a corresponding user query reoccurs. The refresh scheduler refreshes the query response of a cache entry based on the temperature value and age value of the cache entry, if computational resources are available, and limits the refreshing if computational resources are not available.

Other systems, methods, features and advantages will be, or will become, apparent to one with skill in the art upon examination of the following figures and detailed description. It is intended that all such additional systems, methods, features and advantages be included within this description, be within the scope of the invention, and be protected and defined by the following claims. Nothing in this section should be taken as a limitation on those claims. Further aspects and advantages are discussed below in conjunction with the preferred embodiments.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

FIG. 1 is a pictorial diagram of a search engine system in a network environment;

FIG. 2 is a block diagram of a cache data structure according to a specific embodiment;

FIG. 3 is a block diagram of a cache entry data structure according to a specific embodiment;

FIG. 4 is a data structure diagram showing a bucket array having temperature and age indices; and

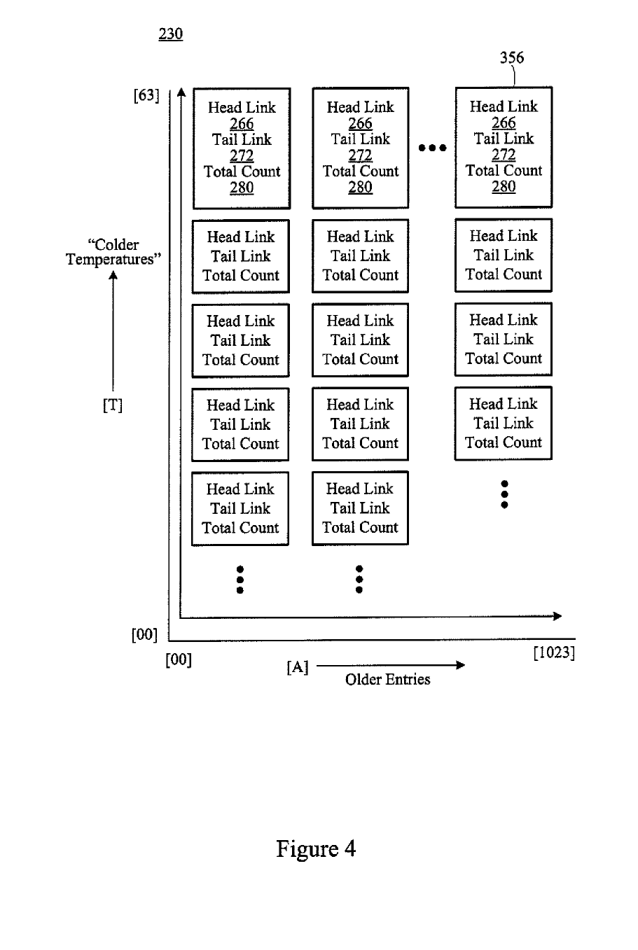

FIG. 5 is a flowchart showing a cache refreshing process according to a specific embodiment.

### DETAILED DESCRIPTION

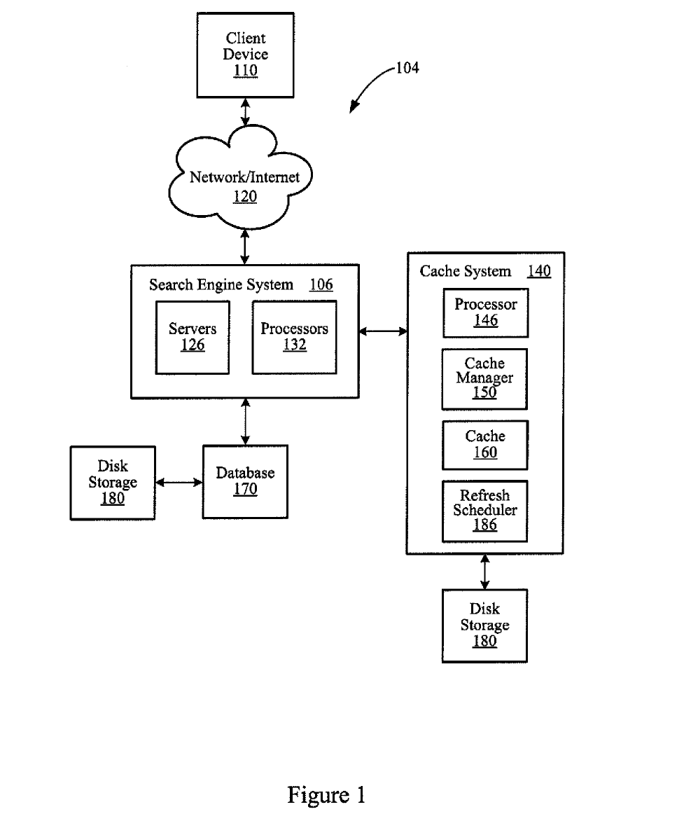

FIG. 1 is a pictorial diagram of a search engine system 106 in a networked environment 104. A user or client device 110 may submit a search request to the search engine system 106 through a network 120, such as the Internet. The search engine system 106 may include one or more servers 126 or back-end servers and processors 132. The processors 132 may have known configurations containing CPUs, memory, interfaces and other hardware and software components.

The search engine system 106 may access a cache system 140 to determine if the results of the user request are resident in a cache 160. The cache system 140 may include a processor 146, a cache manager 150 and the cache 160 or cache memory. The cache memory may be high-speed memory or may be on disk or in RAM.

If the results of a user request are not in the cache (“cache miss”), the search engine system 106 obtains the results from one or more databases 170, and the cache entry is built or populated. A hard-disk 180 or other storage medium may communicate with the search engine system 106 and the cache system 140. Of course, multiple hard disks 180 or hard disk systems may be used and/or coupled to various components. Not all of the depicted components in the networked environment may be required, and some embodiments of the invention may include additional components not shown in the figures. Variations in the arrangement and type of the components may be made without departing from the spirit or scope of the claims as set forth herein. Additionally, different or fewer components may be provided depending on the system or application.

The cache manager 150 or other processor (or process) may communicate with the search engine system 106 and the cache 160. The cache manager 150 manages the cache 160 so that the cache is periodically “refreshed” or “re-warmed” with the results of the queries. In one specific embodiment, cache updating balances the “freshness” of the data in the cache 160 with the workload of the search engine system 106 or server. The cache 160 is not flushed merely because existing cache data may be stale to some degree. Rather, the contents of the cache 160 are updated or refreshed to minimize staleness.

Queries that occur more frequently are given a higher update priority. Similarly, older cache results are also given a higher update priority, depending on the relative frequency of the associated query. In some embodiments, expired non-singleton results (explained later) may be given a higher than usual priority to avoid cache misses. In other embodiments, a cold but expired cache entry may be refreshed before a hot unexpired cache entry. Prioritizing queries for refreshing increases the freshness of the result set for any particular user query or request. When the workload of the server 126 increases, the number of queries that the system refreshes may decrease, and the freshness of the results may gracefully degrade.

Thus, the cache system 140 does not attempt to guarantee absolute freshness of all cache entries, but rather gives refresh priority for queries that occur more frequently and which have expired or have not been recently refreshed. A refresh scheduler 186 may determine which cache entries are refreshed or updated (and when) based on various parameters described below. The refresh scheduler 186 may be a software process or a hardware component, may be part of the processor 146, and/or may be part software process and part hardware component.

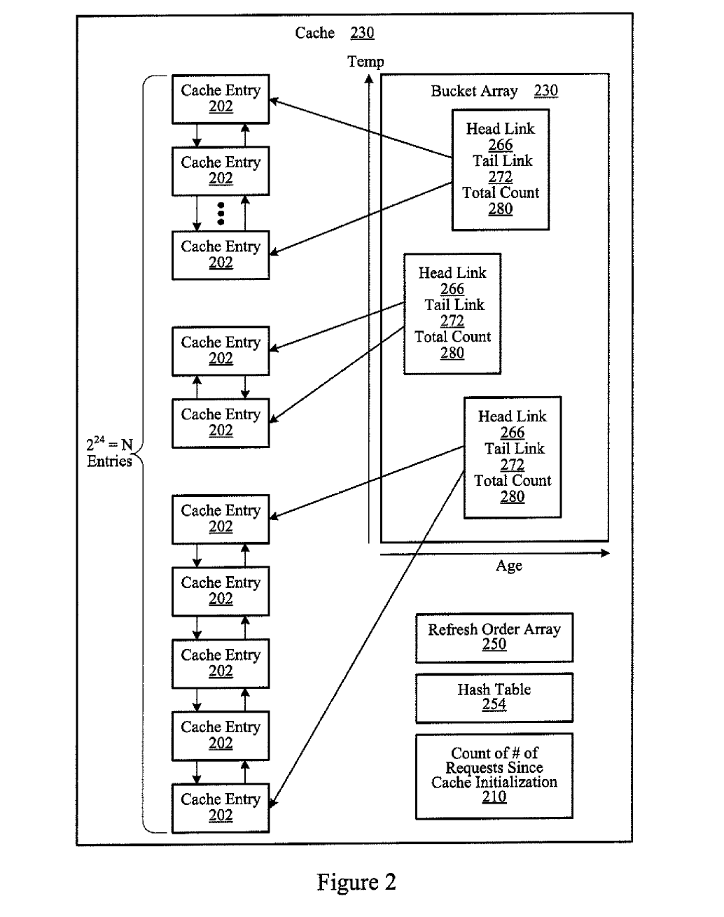

FIG. 2 shows a cache structure 230 generally. The cache structure includes a plurality of cache entries. For example, the cache 160 may include about 10 million to about 20 million cache entries 202, each corresponding to a unique query or user request. Any suitable predetermined number of cache entries 202 may be allocated, depending on system configuration and memory capacity. Cache entries may also be allocated dynamically and created as needed. The cache 160 may also include a counter 210 that tracks the number of requests since cache 160 initialization, a two-dimensional Bucket Array, B[T,A] 230, a Refresh Order Array 250, and a Hash Table 254.

In some embodiments, the number of cache entries 202 may be allocated based on the singleton query time and the expected rate of user requests. In one embodiment, the singleton query time is the maximum time that a query is tracked. In another embodiment, an entry that is on average hit less than once per defined time period is not worth refreshing, there the defined time period establishes the singleton time. In general, a singleton query is a query that appears at most once in a given period of time, where such period of time is part of the configuration parameters of the system. Note that the cache might hold more entries than are needed to determine which entries are singleton entries.

For example, if a particular query is not re-requested after a 48 hour period, it is no longer considered worthwhile, and may be “aged out” of the cache 160 (if the cache is full). For purposes of clarity and for providing specific numerical examples, the singleton time for the examples described herein may be arbitrarily selected to be about 48 hours. Any suitable time period defining the singleton time may be used depending on system requirements, as described below with respect to selection of the “clock-base.”

As an illustrative example relating the frequency of requests to cache size, assume that user requests occur at a rate of 100 requests per second. Thus, in a 48 hour period, the system may receive about 17,280,000 requests. Each unique request may be stored in the cache 160 until the cache becomes filled. For purposes of illustration only, assume that the cache 160 can accommodate about 16 million distinct cache entries 202 (N=2²⁴=16,777,216). The cache system 140 may be designed to have any suitable number of cache entries 202, depending on system capacity. At the request rate of 100 requests (unique requests) per second, the cache 160 will fill in about 48 hours, assuming in this illustrative example that only “unique” (no repeat) requests occur. After that time, the oldest cache entries must be deleted or replaced, as described hereinafter. Note that, for example, a cache hit rate of about 25%, meaning 25% of the requests were found in the cache, would result in only 12,960,000 cache entries being populated in the 48-hour period, even though there were 17,280,000 requests during that period.

Cache management may be based on three main processes, namely aging, temperature updating, and refreshing. Aging differentiates fresher sets of results in the cache 160 from result sets that are more stale. An entry in the cache 160 is fresher compared to another entry if its results have been built or refreshed more recently, according to a time clock. The “age” of a cache entry 202 indicates how fresh or stale the entry is, meaning, how old (or perhaps out-of-date) the entry is.

The “temperature” of a cache entry 202 corresponds to the rate or frequency of the request, that is, how often a particular query occurs relative to the time period defined by the singleton time or other predetermined time period. Queries that occur often are considered to be hot, while queries that occur infrequently are considered to be cold. Hot queries are given a higher priority than cold queries because they are deemed to be more important, as evidenced by their popularity. The combination of the age and temperature of a cache entry 202 determines, in part, when and if the cache entry is refreshed. The age and temperature of each cache entry 202 may be tracked by the Bucket Array B[T,A] 230. Note that various “clock bases” may be used to track time with respect to temperature processes, as discussed below. In contrast to temperature updating, the term “refreshing” refers to updating the results of the query with the most recent or newer data.

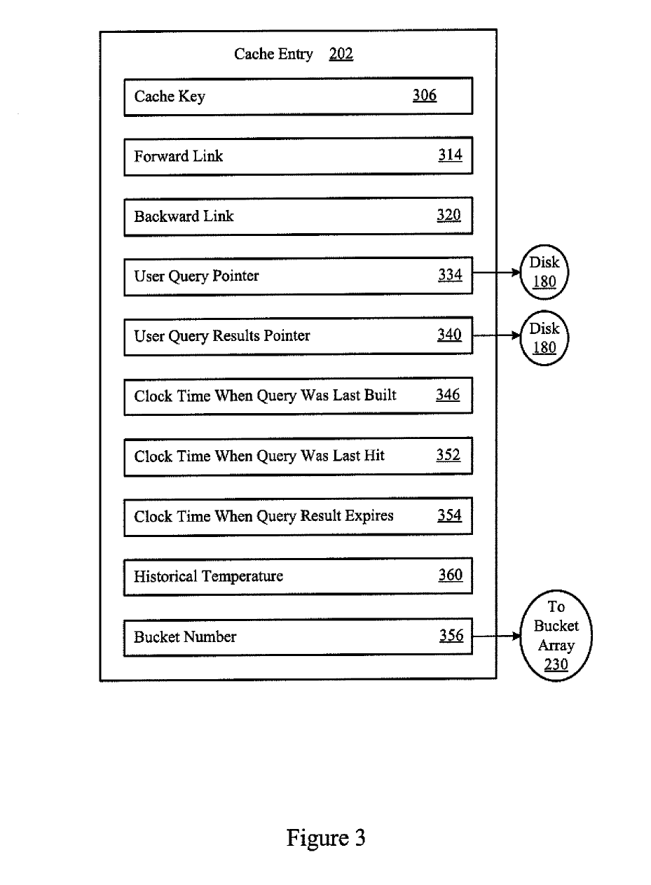

FIG. 3 shows the structure of each of the “N” number of cache entries 202 (N=2²⁴), for example. Each cache entry 202, which is resident in main memory, may contain the following structures and/or variables:

Cache Key 306

Forward Link 314

Backward Link 320

User Query Pointer 334

User Query Results Pointer 340

Clock Time When Query Was Last Built 346

Clock Time When Query Was Last Hit 352

Clock Time When Query Result Expires 354

Historical Temperature 360

Bucket Number (into Bucket Array B[T,A] 230)

The Cache Key 306 is used to look up and save the results of the query. The Cache Key 306 may be created using an MD5 (message-digest 5) hash algorithm, which encodes the user query or search string. Any suitable hashing algorithm may be used to create a key that uniquely identifies the cache entry 202. Typically, the key generated is 16 bytes in length (128 bits), but other key lengths may be used, such as an 8 byte key. The hash table indices may be stored in the Hash Table 254.

The cache entries 202 may be organized as a doubly-linked list. More specifically, the cache entries may be organized as separate groups of doubly-linked lists. Accordingly, each cache entry 202 includes a Forward Link 314 and a Backward Link 320, which identify the next/previous entry in the group. The cache entries 202 may be organized according to other suitable structures, such as a tree structure, a hierarchal structure, or other known structure.

Turning back to FIG. 2, in one embodiment, the Bucket Array 230 may be a 64×1024 array. The index representing the temperature of a particular cache entry 202 (the Y-axis) may range from [0] to [63], where index[0] may represent the hottest temperature and index[63] may represent the coldest temperature. The index representing the age of a particular cache entry 202 (the X-axis) may range from [0] to [1023], where index[0] may represent the “youngest” cache entry 202 (most recently refreshed or built), and index[1023] may represent the “oldest” cache entry 202, which may correspond to the singleton age. Note that the singleton age depends on the clock-base used.

The Bucket Array 230 may be any suitable size depending upon the granularity requirement of the temperature and age parameters. Each bucket contains a Head Link 266, a Tail Link 272, and a Total Count 280. The Head Link 266 and Tail Link 272 point to the subset of doubly-linked lists of cache entries 202. The Total Count 280 indicates the total number of cache entries in that particular doubly-linked list subset. Note that every cache entry 202 is in exactly one bucket based on its age and temperature, and all cache entries 202 in one specific bucket have a similar age and temperature (assuming that an “unhit,” described later, does not indicate a cooler temperature).

In FIG. 3, the cache entry 202 may include the User Query Pointer 334, which points to or identifies the actual user query or search string. The actual user query or search string may be stored on disk 180 rather than in the cache entry 202 due to size constraints. The User Query Pointer 334 identifies the specific user query or search string sent to the search engine system 106 by the user. Note that in some embodiments, the actual user query or search string may not necessarily be found using a pointer. Rather, the actual user query or search string may be found in a parallel array on disk accessed by the hash table entry (offset). In other embodiments, the actual user query or search string may reside in an individual file on disk having a file name based on the cache entry number. For purposes of illustration only, however, the term User Query Pointer will be used when referring to identifying or accessing the actual user query or search string. Regarding terminology, note that users submit “requests” to the engine, and such requests contain a query. The results of the queries are stored in the cache, where each cache entry maps to a query.

The cache entry 202 may include the User Query Results Pointer 340, which identifies or points to the answer or results of the query, usually in the form of links or Web pages. The results of the query may also be stored on disk 180 or external storage due to size constraints. Note that in some embodiments, the actual user query results may not necessarily be found using a pointer. Rather, the user query results may be found in a parallel array on disk accessed by the hash table entry. In other embodiments, the user query results may reside in an individual file on disk having a file name based on the cache entry number. For purposes of illustration only, however, the term User Query Results Pointer will be used when referring to identifying or accessing the user query results.

Various time entries are stored in the cache entry 202 to facilitate cache management processes, such as aging, refreshing, and temperature calculations. Such time entries may include the Clock Time When Query Was Last Built 346 or refreshed, the Clock Time When Query Was Last Hit 352, and the Clock Time When Query Result Expires 354. Note that the Clock Time When Query Was Last Built 346 is based on wall-clock time, while the Clock Time When Query Was Last Hit 352 may vary depending on the clock-base used, as described below.

The Clock Time When Query Result Expires 354 is a real-world expiration time that is associated with every cache entry. The expiration time means that after that point in time, the contents of the cache entry (e.g., the results of the query) are stale and will not be returned in response to the user query. The expiration time may be set based on the data in the result (e.g., an auction page is not returned after the auction is over), or it may be based on a time-to-live parameter (e.g., entries older than two days are deemed stale, for example). Note that the statistics corresponding to the cache entry (such as temperature) are retained even if the cache entry is stale or expired. Thus, a stale cache entry may be refreshed before it is hit. In other embodiments, the expiration time may be unlimited.

Each cache entry 202 also includes the Bucket Number 356 of the two-dimensional Bucket Array B[T,A] 230 to which it corresponds. The Bucket Array 230 position corresponding to a particular cache entry 202 provides the temperature and age of the cache entry 202. Note that the cache entry 202 also includes the Historical Temperature 360, which is a running average of all temperatures calculated for the corresponding cache entry 202. The bucket number 356 may be kept as a “shift relative value” so that array contents may be shifted without modifying any entry contents.

To process a cache entry for refresh (and replacement when the cache is full), the particular bucket may be accessed, and the Head Link (or Tail Link) is used to identify the first (or last) cache entry 202 of the sub-set of cache entries 202. Each cache entry has a corresponding Bucket Number 356, as defined by the T and A indices. A particular bucket may be empty (Total Count=0), meaning that there is no doubly-linked list associated with that bucket. Accordingly, if the Total Count equals zero, there are no cache entries having the temperature and age of that particular bucket. Inspection of any one non-empty bucket permits identification of all corresponding cache entries (all having the same temperature and age) by traversing the doubly-linked listed defined by the Head Link and the Tail Link of that bucket.

Conversely, inspection of any one cache entry 202 permits identification of its corresponding single Bucket Number 356. The temperature and age of a cache entry are contained in the cache entry 202 structure, while the bucket is used to group cache entries together that have a similar age and temperature, so that cache entries with a particular age and temperature can be easily found.

Based on the illustrated example, the Bucket Array 230 may contain 65,536 (2¹⁶=64*1024) distinct and separate doubly-linked lists of cache entries 202, and each valid cache entry is represented once and only once, somewhere in one of the distinct and separate doubly-linked lists. Because in this specific example there are 224 cache entries and only 216 buckets, each bucket, on average, may define a doubly-linked list containing many cache entries 202. Of course, some buckets may define a null doubly-linked list (no cache entries), while other buckets may define a very long doubly-linked list. The size of the Bucket Array 230 (T*A) may be substantially smaller than the number of cache entries 202, and in the illustrated example, this factor may be equal to about 2⁸, or 256 (2²⁴/2¹⁶=2⁸). Note that the number of cache entries does not affect the performance of any of the processes.

The two-dimensional Bucket Array 230 classifies each cache entry 202 according to its temperature and age. Increasing the T and A dimensions (maximum index value) provides greater resolution to the cache, and permits a more fine-grained separation. Assuming that the volume of queries is high, it may be more important to have greater resolution in the age or [A] dimension (X-axis). Low age resolution could result in mixing very old queries with fresher entries. The size of the age dimension may be selected based on the memory requirement of the specific application. Any suitable dimension may be chosen. None of the processes described herein depend on the size of the age or temperature dimension in the bucket array. However, a greater age dimension provides better age resolution when choosing an entry to refresh.

The temperature of cache entry 202, as evidenced by its [T] position (Y-axis) or index in the Bucket Array 230, establishes a priority among the cache entries 202. A “hot” cache entry 202 has a low index, for example, with the hottest temperature assigned to B[0,A]. The “coldest” cache entry 202 has a high index, with the coldest temperature assigned to B[63,A], which may correspond to a singleton query. The position of a cache entry 202 in the Bucket Array 230 may establish the priority for refreshing a particular cache entry. Hotter, older cache entries are refreshed at a higher level of priority than cooler, younger cache entries. Note that there may be a minimum age for refresh to occur so that “very hot” entries are not refreshed, as they are already very fresh and do not require further refreshing.

Various times are recorded to facilitate management of the cache, which may be based on various clock bases. For example, the arrival time of a query and the time of cache hit may be tracked. However, the clock-base through which such variables are tracked or updated may affect system performance. Thus, different clock bases may be used.

A first clock-base, referred to as “wall-clock time,” is the real-world time, such as, for example, Greenwich Mean Time (GMT) or some other time standard. When an event occurs, the wall-clock time associated with that event is its actual event time or arrival time. The system preferably uses wall-clock time to perform aging processes. However, the time base selection for performing temperature calculations is more complex.

Using wall-clock time to perform temperature processes may not account for system maintenance or other “down-time” processes. For example, computer system and/or cache systems may be temporarily and periodically shut down for maintenance or for other reasons. Perhaps the cache is frozen for five minutes every twelve hours for system maintenance. During that time, no user requests are processed, and a query may be prematurely aged and deemed to be cooling-off because its time of arrival has been delayed by the length of the system shut-down. This tends to shift more queries toward the singleton buckets and skew the age distribution in the Bucket Array 230. Accordingly, depending on the process run, a different clock-base, other than wall clock time, may be used. An alternate clock base may be referred to as “logical time.”

In one embodiment, the clock-base or logical time for temperature calculations may be based on the real time “ticked,” but only when the cache is running. In another embodiment, the clock-base or logical time for temperature calculations may be based on when requests or queries occur. That is, the clock is “upticked” when a request occurs. In yet another embodiment, the clock-base or logical time for temperature calculations may be based on cache misses. That is, the clock is “upticked” when a cache miss occurs. Any of the clock bases described may be used depending on the application and specific function executed.

The system continuously updates the Bucket Array 230 to account for aging and changes in temperature. As described above, the temperature of a query (cache entry) relates to its frequency of occurrence relative to the singleton time. Thus, the more frequently a particular query occurs, the higher its corresponding temperature. Note that the temperature represents the measured frequency of a particular query. Temperature updating is not the result of any aging processes because aging relates to the freshness or staleness of the data in the cache, whereas until a cache refresh occurs, even frequently requested queries (hot queries) may return the same “somewhat stale” data. Of course, the present system may minimize the degree of staleness, especially as the temperature and age increases.

Note that the true temperature of a cache entry is not really known until there is a cache hit because the temperature value only provides the temperature as of the last cache hit. The reciprocal of the “time since the last hit” yields the hit rate, which may be averaged with the historical temperature to determine the latest hit rate, and thus the bucket in which it belongs. Lack of a cache hit does not necessarily indicate a particular hit rate, but it does set an upper bound on the hit rate.

In that regard, two events may change the temperature bucket of a cache entry, which may cause the cache entry to move from one temperature bucket to another. The first event is a cache hit. When a cache hit occurs, even if the results are expired, a new temperature is calculated and the cache entry temperature is updated, meaning the cache entry is moved to the correct bucket.

Another event that may change the temperature bucket of a cache entry is an attempt to refresh the cache entry. Before refreshing an entry, an upper temperature limit is calculated by determining its “would-be” temperature or how hot it would be if a cache hit occurred at the current time. If the would-be calculated temperature corresponds to the same bucket or a hotter bucket, then the cache entry remains in the same bucket, and the cache entry is refreshed. If the would-be calculated temperature indicates that the bucket in which it currently resides is too hot (meaning it does not deserve to be in such a hot bucket), the cache entry is moved to a cooler bucket, and the cache entry is not refreshed. Updating the temperature bucket of a cache entry is performed one cache entry at a time.

When a cache hit occurs, a new temperature is calculated for that particular query (cache entry). The historical temperature of a cache entry 202 remains the same until a new cache hit occurs. The historical temperature is not changed when moving the cache entry to a new bucket on a refresh attempt. The new temperature may be the average of the historical temperature and the temperature since last the hit (current temperature). This smoothes the randomness in arrivals of the same query. Based on the new temperature of the cache entry 202, the cache entry is removed from the current temperature bucket (by manipulating the doubly-linked list), and entered into the new temperature bucket. Thus, the corresponding cache entry position would appear to move vertically in the Bucket Array 230 within its existing age column. Specifically, movement would appear to be vertically downward for higher temperatures and vertically upward for cooler temperatures. The corresponding cache entry 202 is also updated with its new temperature index of the Bucket Array 230.

The age of cache entry 202, as indicated by its age index in the Bucket Array 230, may be based on wall clock time (or other time base in some embodiments) since last execution of the query, that is, rebuilding or refreshing the results of the cache entry. The Bucket Array 230 is aged periodically to change the age of its corresponding cache entries to reflect the passage of time. Aging the buckets may be performed by shifting their contents rightward, toward higher age indices. The update or age-shift of the cache entry is based upon the singleton time. In some embodiments, the cache entries may be aged based on a clock-base other than wall clock time, as described above with respect to the different clock bases.

When results of a new query are obtained, it is assigned a bucket with an age of zero (B [T, 0]) because it represents the newest or freshest possible data. The cache system 140 may perform an age-shift every L/1023 seconds. When an age-shift occurs, the contents of B[T,A] are shifted into B[T,A+1] for all A<1022. Bucket B[T, 0] is thus zero-filled. However, the contents of the “next to oldest” bucket B[T,1022] are “merged” into (added to) the oldest bucket B[T,1023]. Bucket B[T,1023] is not shifted to the right. “Shifting” may be accomplished by simple manipulation of the linked list head/tail pointers.

Thus, the cache entries corresponding to B [T,1022] are added to B[T,1023], and the cache entries already residing in or corresponding to B[T, 1023] remain unchanged. The oldest bucket, B[T,1023], is not shifted to the right because no additional buckets exist in the illustrated example. The above aging process is performed for all values of T, which may range in the illustrated example from 0 to 63. The contents of B[T, 1023] may represent the expired queries, although there may be expired queries in other buckets.

In one specific embodiment, the order in which to refresh the cache may be based on the order that is most likely to reduce the degree of staleness of cache hit results. Because all the cache entries 202 that are in the same bucket are similar or identical in age and temperature, the issue becomes which non-empty bucket to choose in sequence. Buckets having a higher temperature contribute more or “affect” the staleness of the cache to a greater degree than lower temperature buckets because these represent queries that are more frequently requested.

Similarly, buckets having a higher age contribute more to cache staleness because their results are the oldest. Thus, if there are any cache entries in bucket B[0, 1023], this bucket may be refreshed first because it is the hottest and the oldest. Of course, if that bucket is empty, then the second most important bucket is chosen, until all buckets are refreshed.

Due to the way that age and temperature are calculated, choosing buckets for refresh may be based on the largest value provided by the following equation: Bucket to Refresh=Largest ((63-T) A). Note that the processes described herein are not restricted to using this function, and any suitable function f(T,A) returning a value between one and the total number of buckets (e.g., [1,TOTAL_NUMBER_OF_BUCKETS], can be used. The results of such ordering calculations may be stored in the Refresh Order Array 250 as a linked list of buckets. Note that the Refresh Order Array 250 may not contain any buckets corresponding to B[63,*] because these buckets contain singleton queries. Similarly, the Refresh Order Array 250 may not contain any entries for buckets that contain results that are too fresh. Thus, the buckets corresponding to B[*, 0] are never refreshed. Other ages may be exempt from refreshing based on the minimum age for refreshing.

Populating the Refresh Order Array 250 may occur at cache or system initialization time because the populating process is based on parameters that do not change within a single run. In some embodiments, the value of T*A is added to the temperature score of every bucket that contains only expired entries. This may ensure all expired entries are refreshed first. Accordingly, the cache may be refreshed, depending on system workload, by traversing the Refresh Order Array 250 in order to obtain the specific bucket to refresh.

The refreshing strategy may use all available refresh queries to reduce the average age of the cache entries. Under heavy system load, fewer (or even no) refreshes may be executed, which may result in a higher average degree of staleness of queries. However, under reduced system load, more refreshes occur, thus improving the freshness of the cache results returned.

When a user query or request occurs, the cache is searched to see if it exists in the cache. If a corresponding cache entry 202 does not exist in the cache, a new cache entry is created and linked into the “coldest” and “youngest” bucket (for example, B[63,0]). In one specific embodiment, the cache entries are dynamically allocated so that new cache entries may be added to specific doubly-linked lists as needed, up to the maximum cache capacity.

If the cache is full, an older cache entry must be replaced (deleted) with the new cache entry information. Accordingly, the cache entry 202 associated with bucket B[63, 1023] may be reused, which represents the coldest and oldest cache entry. This assumes that there may be some queries that have been requested only once. In the unlikely case that this bucket is empty, all oldest buckets are inspected, namely B[62, 1023], B[61, 1023], . . . If these buckets are all empty, then newer singleton buckets are inspected, namely, B[63, 1022], B[63, 1021], . . . until a bucket is found that is not empty. Note that in practice, there are always some entries in B[63, *], that is, the coldest “row,” due to the nature of queries. The new cache entry is populated with values set forth above with respect to FIG. 3. For the new cache entry, the Historical Temperature is set to a value of 63 and corresponds to Bucket Array B [63,0].

When a cache hit occurs, that is, a query is found in the cache, the previous hit time may be subtracted from the current hit time to obtain the interval “I” in hit time units. Given a singleton time of “S” in hit time units and a historical temperature of “H,” the new temperature “T” is equal to (I/(S/64)+H)/2. The value of “T” may be either larger or smaller than “H.” Note that the processes described herein are not restricted to using this function, and any suitable function T(I, S, H) returning a value between one and the maximum temperature (e.g., [1,MAX_TEMPERATURE], may be used. In one specific embodiment, for example, the function T(I, S, H) may be T=(I/(S/64)+H/4)/2, where the historical temperature has lower weight. Note that Historical Temperature is set to 63 (coldest possible) on a cache miss because any previous cache hit must be at least a “singleton time ago,” or there would already be an entry in the cache.

To update the cache entry 202 due to the cache hit, the cache entry is moved to bucket B[T,A], as described above. The value of A is the same as its current bucket index A because a cache hit has no effect on the age of the cache entry. Rather, a cache hit only affects the temperature. Also note that a cache hit does not change the time of last execution. The following parameters may be set as follows:

Time of last cache hit=present hit time;

Historical Temperature=T.

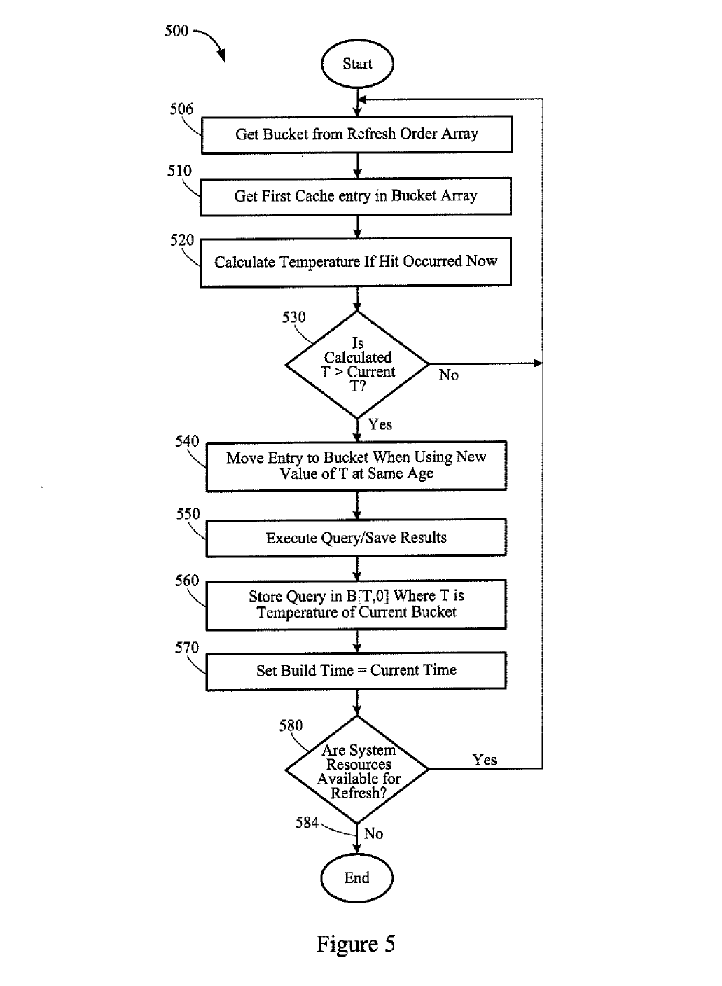

FIG. 5 is a flowchart showing the process 500 that may be taken to determine which query (cache entry) to refresh when system resources are available for refreshing the cache. First, the Refresh Order Array 250 is inspected to find the first bucket that contains a cache entry (Act 506). No refresh is performed if all eligible buckets are empty. The first cache entry in the bucket is selected (Act 510). The temperature bucket T that the query would be assigned if it were hit at the present time is then calculated (Act 520). This value represents the lower boundary of the value of T that will be calculated on the next hit. If the new value of T is greater than the value of T for the current bucket, that is, the entry is colder than its current bucket (Act 530), then it is moved to the bucket with temperature T and the same age (Act 540). Thus it is no longer a candidate for refresh. This may be referred to as “un-hit” because the cache entry is inspected when a cache hit did not occur. Note that moving the cache entry to a new bucket based on an “unhit” process does not affect the historical temperature in the cache entry.

Next, the query may be executed (the databases searched) and the new results are saved (Act 550). The cache entry is then moved to bucket B[T, 0], where T is the same temperature as its current bucket (Act 560). The calculation for the value of T may be ignored, and the Time When Query Last Built is set to the present time (Act 570). Note that the updating process does not change the historical temperature, which was set on the last hit.

The updating process slows when system resources are unavailable or marginally available so that the freshness of the cache degrades gracefully. If no system resources are available to perform cache updating (Act 580), no updating is performed at that time (Act 584), and updating is revisited when system resources become available. When system resources are again available, the Refresh Order Array is searched for another query to refresh (Act 506), and the updating process 500 continues based on available system resources. In one embodiment, deciding that it is time to refresh can be performed by setting a target number of queries per second, and using whatever slots are left in a second for refreshes. In another embodiment deciding that it is time to refresh can be performed by dynamically estimating the load of the servers and performing refreshing when the servers have spare capacity for processing.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

The illustrations of the embodiments described herein are intended to provide a general understanding of the structure of the various embodiments. The illustrations are not intended to serve as a complete description of all of the elements and features of the apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A method for refreshing a cache based on query responses provided in response to queries, the method comprising:
providing a cache entry for each unique query, if space is available in the cache;
assigning a temperature value to each cache entry based on a frequency of occurrence of the corresponding query;
assigning an age value to each cache entry based on a time of last refresh or creation, of the corresponding query response;
periodically updating the age value of the cache entries;
updating the temperature value of a cache entry when a corresponding query reoccurs;
refreshing the query response of a cache entry based on the temperature value and the age value of the cache entry, if computational resources are available; and
limiting the refreshing if computational resources are not available.

2. The method of claim 1, further comprising providing a bucket array having a temperature index and an age index, wherein a location in the bucket array defined by the temperature index and age index contains an indication of the cache entry having the corresponding temperature and age.

3. The method of claim 1, wherein the indication of the cache entry in the bucket array is based on a linked list or a pointer.

4. The method of claim 3, wherein the size of the bucket array is substantially smaller than the number of cache entries.

5. The method of claim 2, wherein the age of each cache entry is updated at predetermined time intervals.

6. The method of claim 5, wherein the predetermined time interval is based on a maximum expected lifetime of a query response or a singleton time period, and the maximum age index of the bucket array.

7. The method of claim 1, further comprising updating the age value of each cache entry for which the corresponding query response has not been refreshed for a predetermined period of time.

8. The method of claim 5, wherein a high temperature corresponds to a high frequency of occurrence of the corresponding query, and cache entries having a higher temperature value and a greater age value are refreshed before cache entries having a lower temperature value and lesser age value.

9. The method of claim 1, wherein the temperature of a cache entry is updated based on an attempted cache entry refresh.

10. A computer-readable storage medium having processor executable instructions to refresh a cache based on query responses provided in response to queries, by performing the acts of:
providing a cache entry for each unique query, if space is available in the cache;
assigning a temperature value to each cache entry based on a frequency of occurrence of the corresponding query;
assigning an age value to each cache entry based on a time of last refresh or creation, of the corresponding query response;
periodically updating the assigned age value of the cache entries;
updating the temperature value of a cache entry when a corresponding query reoccurs;
refreshing the query response of a cache entry based on the temperature value and age value of the cache entry, if computational resources are available; and
limiting the refreshing if computational resources are not available.

11. The computer-readable storage medium of claim 10, further comprising processor executable instructions to cause a processor to perform the acts of providing a bucket array having a temperature index and an age index, wherein a location in the bucket array defined by the temperature index and age index contains an indication of the cache entry having the corresponding temperature and age.

12. The computer-readable storage medium of claim 11, further comprising processor executable instructions to cause a processor to perform the acts of assigning the bucket array a size substantially smaller than the number of cache entries.

13. The computer-readable storage medium of claim 11, further comprising processor executable instructions to cause a processor to perform the acts of periodically updating the age value of each cache entry at predetermined time intervals.

14. The computer-readable storage medium of claim 13, further comprising processor executable instructions to cause a processor to perform the acts of periodically updating the age value based on a maximum expected lifetime of a query response or a singleton time period, and the maximum age index of the bucket array.

15. The computer-readable storage medium of claim 10, further comprising processor executable instructions to cause a processor to perform the acts of periodically updating the age value of each cache entry for which the corresponding query response has not been refreshed for a predetermined period of time.

16. The computer-readable storage medium of claim 13, further comprising processor executable instructions to cause a processor to perform the acts of refreshing cache entries having a higher temperature value and a greater age value before cache entries having a lower temperature and a lesser age, where a higher temperature value corresponds to a high frequency of occurrence of the corresponding query.

17. The computer-readable storage medium of claim 13, further comprising processor executable instructions to cause a processor to perform the acts of periodically updating the temperature value of a cache entry based on an attempted cache entry refresh.

18. A method for refreshing a cache based on user queries and query responses provided in response to the user query, the method comprising:
building a cache entry for each unique user query, if space is available in the cache;
assigning a temperature value to each cache entry based on a frequency of occurrence of the corresponding user query;
assigning an age value to each cache entry based on a time of last refresh or creation, of the corresponding query response;
arranging a bucket array with a temperature index and an age index, wherein a location in the bucket array defined by the temperature index and age index contains an indication of the cache entry assigned the corresponding temperature value and age value;
periodically updating the age value of the cache entries;
updating the temperature value of a cache entry when a corresponding user query reoccurs; and
refreshing the query response of a cache entry based on the temperature value and the age value of the cache entry, if computational resources are available, and limiting the refreshing if computational resources are not available.

19. The method of claim 18, wherein the indication of the cache entry in the bucket array is based on a linked list or a pointer to the cache entry.

20. The method of claim 19, wherein the size of the bucket array is substantially smaller than the number of cache entries.

21. The method of claim 18, wherein the age value of each cache entry is periodically updated at predetermined time intervals.

22. The method of claim 21, wherein the predetermined time interval is based on a maximum expected lifetime of a query response or a singleton time period, and the maximum age index of the bucket array.

23. The method of claim 18, further comprising periodically updating the age value of each cache entry for which the corresponding query response has not been refreshed for a predetermined period of time.

24. A cache management system comprising:
a processor in communication with a cache, the cache having a plurality of cache entries;
a server configured to receive a user query and provide a query response to the processor;
a bucket storage structure accessible by a temperature index and an age index, wherein a location in the bucket storage structure defined by the temperature index and age index contains an indication of the cache entry assigned the corresponding temperature and age, where a temperature value is assigned to each cache entry based on a frequency of occurrence of the corresponding user query, and an age value is assigned to each cache entry based on a time of last refresh or creation, of the corresponding query response;
a refresh scheduler configured to periodically update the assigned age value of the cache entries, and update the temperature value of a cache entry when a corresponding user query reoccurs; and
wherein the refresh scheduler refreshes the query response of a cache entry based on the temperature value and the age value of the cache entry, if search computational resources are available, and limits the refreshing if computational resources are not available.

25. A method for refreshing a cache based on query responses provided in response to queries, the method comprising:
providing a cache entry for each unique query, if space is available in the cache;
assigning a rank value to each cache entry based on a property of the corresponding query;
updating the rank value of the cache entry when a corresponding query reoccurs;
refreshing the query response of a cache entry based on the rank value of the cache entry, if computational resources are available; and
limiting the refreshing if computational resources are not available.

26. A method of claim 25 further comprising:
updating the rank value based on a frequency of occurrence of the corresponding query; and
updating the rank value based on a time of last refresh or creation of the corresponding query response.
